(19) United States
(12) Patent Application Publication
(10) Pub. No.: US 2019/0162246 A1
(43) Pub. Date: May 30, 2019

(54) WEDGE PLATE WITH ROTATED SEGMENTS AND A CLUTCH INCLUDING A WEDGE PLATE WITH ROTATED SEGMENTS

(71) Applicant: Schaeffler Technologies AG & Co. KG, Herzogenaurach (DE)

(72) Inventors: Jeffrey Shewell, Rochester, MI (US); Kate Higdon, Royal Oak, MI (US); Joshua Hixenbaugh, Wooster, OH (US); Philip George, Wooster, OH (US); Debora Manther, Royal Oak, MI (US)

(73) Assignee: Schaeffler Technologies AG & Co. KG, Herzogenaurach (DE)

(21) Appl. No.: 15/826,828

(22) Filed: Nov. 30, 2017

(51) Int. Cl. F16D 41/063; F16D 15/00

(52) U.S. Cl. CPC F16D 41/063; F16D 15/00

(57) ABSTRACT

A wedge plate, including: a first plurality of segments including first and second segments and a second plurality of segments. The first segment includes: a first radially outer surface in a shape of a portion of a first circle; and a first radially inner surface including a first ramp extending radially outwardly in a first circumferential direction. The second segment includes: a second radially outer surface in a shape of a portion of a second circle, the second circle non-co-linear with the first circle; and a second radially inner surface including a second ramp extending radially outwardly in the first circumferential direction. Each segment in the second plurality of segments connects a respective pair of circumferentially adjacent segments included in the first plurality of segments.

### TECHNICAL FIELD

The present disclosure relates to a wedge plate, for a wedge plate clutch, with rotated segments, and to a wedge plate clutch with a wedge plate with rotated segments. The rotated segments increase contact between the wedge plate and inner and outer races for the wedge plate clutch in a locked mode.

### BACKGROUND

FIG. 8 is a front view of prior art wedge plate 300 for a wedge plate clutch. Wedge plate 300 includes segments 302 connected by respective segments 304. Each segment 302 includes radially outer surface 306 and radially inner surface 308. Each surface 306 forms a respective portion of circle C3 having radius R2. Each surface 308 includes ramp 310 extending radially inwardly along circumferential direction CD1.

FIG. 9 is a front view of prior art wedge plate clutch 312, with wedge plate 300 shown in FIG. 8, in a locked mode for clutch 312. Clutch 312 includes axis of rotation AR, outer race 314, and inner race 316. Wedge plate 300 is radially disposed between races 314 and 316. Outer race 314 includes radially inner surface 318 at uniform distance 320 from axis of rotation AR. Distance 320 is less than radius R2. Inner race 316 includes ramps 322 extending radially inwardly along direction CD1.

In a locked mode for clutch 312, plate 300 and races 314 and 316 are non-rotatably connected. However, only small portions of respective surfaces 306 for three of the five segments 302 are in contact with surface 318. Specifically: each of segments 302A, 302B and 302C have small respective areas of contact 324 between surfaces 306 and 318; and, there is no contact between race 314 and segments 302D and 302E. Further, areas of contact 324 between ramps 322 and ramps 310 are also small. The relatively small extent of areas of contact 324 limits the torque-carrying capacity of clutch 312.

### SUMMARY

According to aspects illustrated herein, there is provided a wedge plate, including: a first plurality of segments including first and second segments and a second plurality of segments. The first segment includes: a first radially outer surface in a shape of a portion of a first circle; and a first radially inner surface including a first ramp extending radially outwardly in a first circumferential direction. The second segment includes: a second radially outer surface in a shape of a portion of a second circle, the second circle non-co-linear with the first circle; and a second radially inner surface including a second ramp extending radially outwardly in the first circumferential direction. Each segment in the second plurality of segments connects a respective pair of circumferentially adjacent segments included in the first plurality of segments.

According to aspects illustrated herein, there is provided a wedge plate clutch, including: an axis of rotation; an outer race with a first radially inner surface at a radial distance from the axis of rotation; an inner race; and a wedge plate radially disposed between the inner race and the outer race and including a first plurality of segments. The first plurality of segments includes first and second segments. The first segment includes a first radially outer surface: in contact with the first radially inner surface; and in a shape of a portion of a first circle having a radius equal to the radial distance. The second segment includes a second radially outer surface: in contact with the first radially inner surface; and in a shape of a portion of a second circle having a radius equal to the radial distance.

According to aspects illustrated herein, there is provided a method of operating a wedge plate clutch, including: an inner race with a first radially outer surface having a first ramp sloping radially outwardly in a first circumferential direction about an axis of rotation for the wedge plate clutch; an outer race including a first radially inner surface at a uniform radial distance from the axis of rotation; and a wedge plate radially disposed between the inner and outer races, the wedge plate including a first segment with a second radially outer surface in the shape of a portions of a first circle having a radius equal to the uniform radial distance and with a second radially inner surface including a second ramp sloping radially outwardly in the first circumferential direction. The method comprises: contacting the first radially inner surface with the second radially outer surface; contacting the first ramp with the second ramp; rotating the inner race in a second circumferential direction, opposite the first circumferential direction; sliding, in the second circumferential direction, the first ramp along the second ramp; displacing the wedge plate radially outwardly; and non-rotatably connecting the inner race, the wedge plate and the outer race.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a front view of a wedge plate, for a wedge plate clutch, with rotated segments;

FIG. 2A shows two segments for the wedge plate from FIG. 1, illustrating rotation and tangential off-set of at least two of the segments for the wedge plate;

FIG. 2B shows the three remaining segments for the wedge plate from FIG. 1, illustrating rotation and tangential off-set of the segments for the wedge plate;

FIG. 2C is a detail of area 2C in FIG. 1;

FIG. 3 is a detail of area 3 in FIG. 2A;

FIG. 4 is a cross-sectional view generally along line 4-4 in FIG. 1;

FIG. 5 is a front view of a wedge plate clutch, with the wedge plate shown in FIG. 1, in a locked mode;

FIG. 6 is a cross-sectional view generally along line 6-6 in FIG. 5;

FIG. 7 is a perspective view of a cylindrical coordinate system demonstrating spatial terminology used in the present application;

FIG. 8 is a front view of a prior art wedge plate for a wedge plate clutch; and,

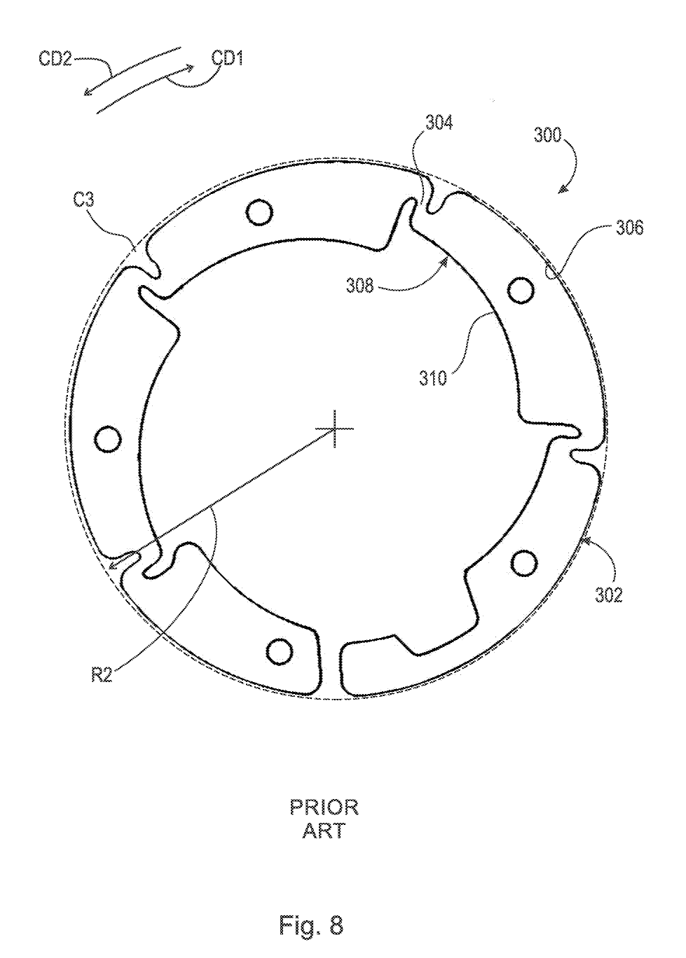

FIG. 9 is a front view of a prior art wedge plate clutch, with the wedge plate shown in FIG. 8, in a locked mode.

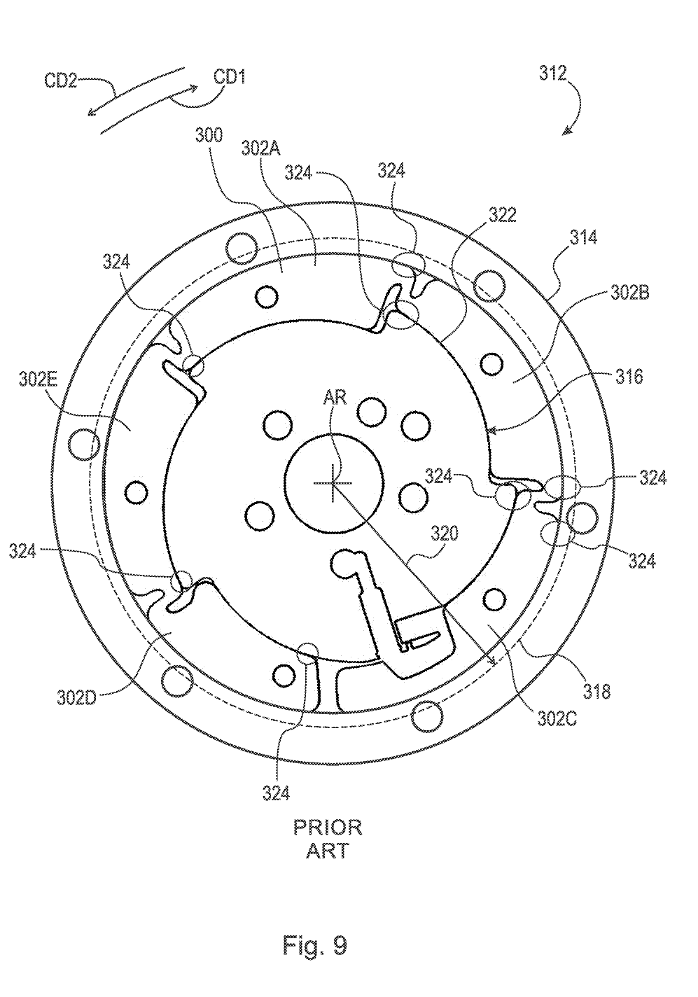

### DETAILED DESCRIPTION

At the outset, it should be appreciated that like drawing numbers on different drawing views identify identical, or functionally similar, structural elements of the disclosure. It is to be understood that the disclosure as claimed is not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It should be understood that any methods, devices or materials similar or equivalent to those described herein can be used in the practice or testing of the disclosure.

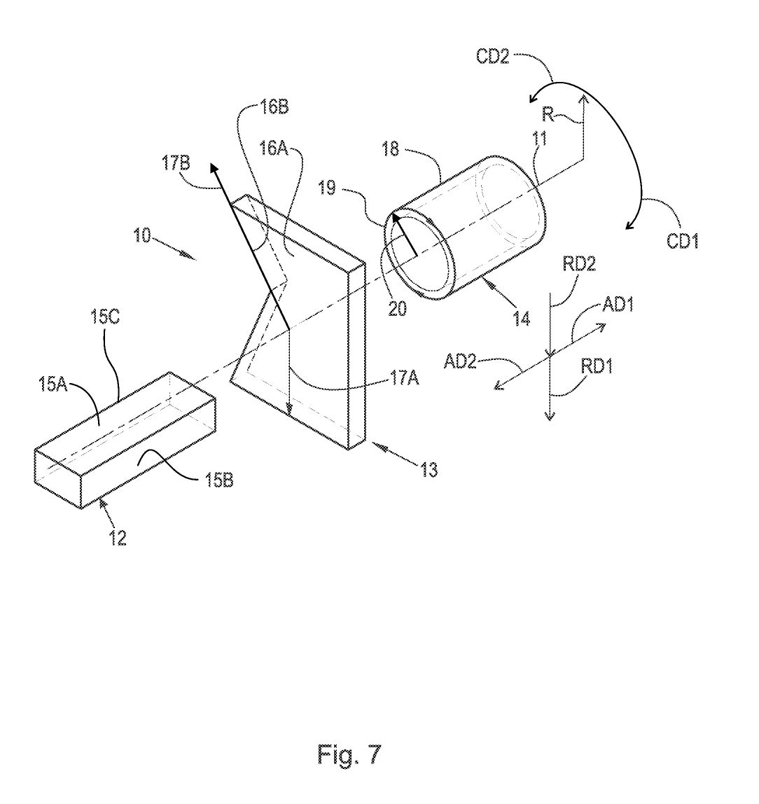

FIG. 7 is a perspective view of cylindrical coordinate system 10 demonstrating spatial terminology used in the present application. The present application is at least partially described within the context of a cylindrical coordinate system. System 10 includes axis of rotation, or longitudinal axis, 11, used as the reference for the directional and spatial terms that follow. Opposite axial directions AD1 and AD2 are parallel to axis 11. Radial direction RD1 is orthogonal to axis 11 and away from axis 11. Radial direction RD2 is orthogonal to axis 11 and toward axis 11. Opposite circumferential directions CD1 and CD2 are defined by an endpoint of a particular radius R (orthogonal to axis 11) rotated about axis 11, for example clockwise and counterclockwise, respectively.

To clarify the spatial terminology, objects 12, 13, and 14 are used. As an example, an axial surface, such as surface 15A of object 12, is formed by a plane co-planar with axis 11. However, any planar surface parallel to axis 11 is an axial surface. For example, surface 15B, parallel to axis 11 also is an axial surface. An axial edge is formed by an edge, such as edge 15C, parallel to axis 11. A radial surface, such as surface 16A of object 13, is formed by a plane orthogonal to axis 11 and co-planar with a radius, for example, radius 17A. A radial edge is co-linear with a radius of axis 11. For example, edge 16B is co-linear with radius 17B. Surface 18 of object 14 forms a circumferential, or cylindrical, surface. For example, circumference 19, defined by radius 20, passes through surface 18.

Axial movement is in axial direction AD1 or AD2. Radial movement is in radial direction RD1 or RD2. Circumferential, or rotational, movement is in circumferential direction CD1 or CD2. The adverbs “axially,” “radially,” and “circumferentially” refer to movement or orientation parallel to axis 11, orthogonal to axis 11, and about axis 11, respectively. For example, an axially disposed surface or edge extends in direction AD1, a radially disposed surface or edge extends in direction RD1, and a circumferentially disposed surface or edge extends in direction CD1.

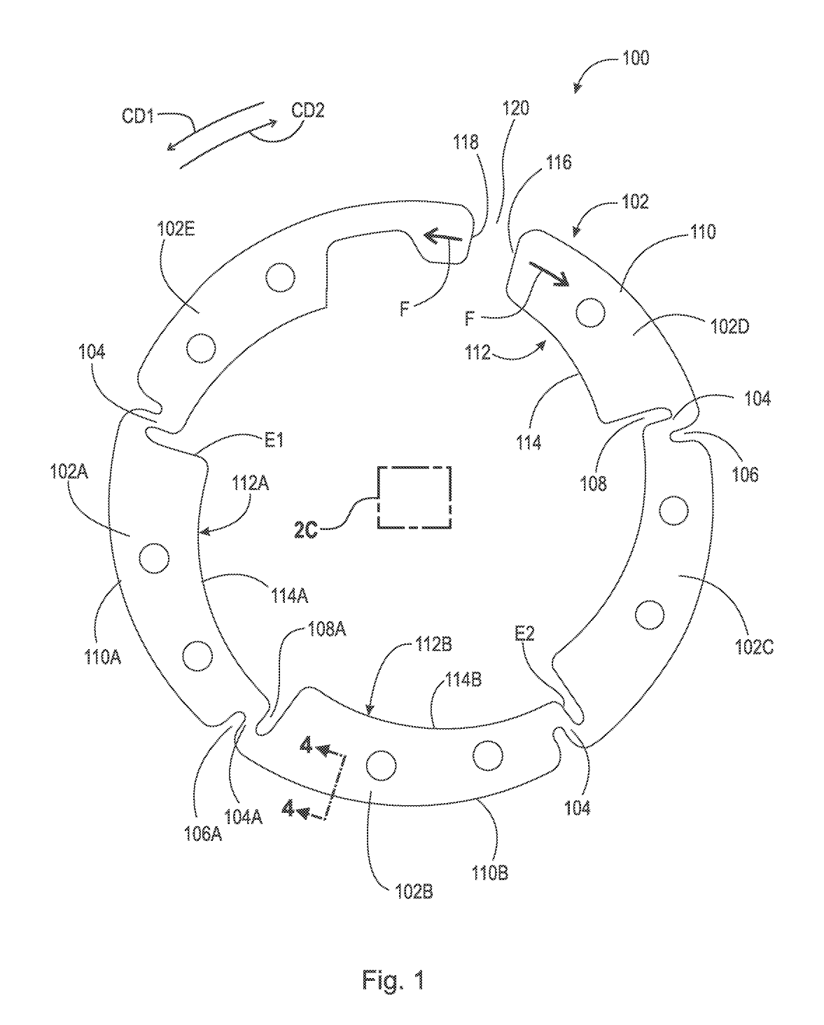

FIG. 1 is a front view of wedge plate 100, for a wedge plate clutch, with rotated segments. Wedge plate 100 includes: segments 102; segments 104; slots 106; and slots 108. Each segment 102 includes: radially outer circumferential surface 110; and radially inner circumferential surface 112. Each inner circumferential surface 112 includes ramp 114 extending radially outwardly along circumferential direction CD1. For example: segment 102A includes surface 110A, surface 112A, and ramp 114A; and segment 102B includes surface 110B, surface 112B, and ramp 114B. In general, a reference character “[digit][digit][digit][letter]” designates a specific example of an element labeled as “[digit][digit][digit].” For example, segment 102A is a specific example from among segments 102.

Each segment 104 connects a respective pair of circumferentially adjacent segments 102. For example, segment 104A connects segments 102A and 102B. Each segment 104 is bounded, at least in part, by a respective slot 106 and a respective slot 108. For example, segment 104A is bounded by slots 106A and 108A.

Each slot 106: extends radially inwardly from a pair of circumferentially adjacent surfaces 110; and is bounded, at least in part, by a pair of circumferentially adjacent segments 102 in direction CD1 and in direction CD2, opposite direction CD1. For example, slot 106A: extends radially inwardly from surfaces 110A and 110B; and is bounded by segments 102B and 102A in directions CD1 and CD2, respectively.

Each slot 108: extends radially outwardly from a pair of circumferentially adjacent surfaces 112; and is bounded, at least in part, by a pair of circumferentially adjacent segments 102 in directions CD1 and CD2. For example, slot 108A: extends radially inwardly from surfaces 112A and 112B; and is bounded by segments 102B and 102A in directions CD1 and CD2, respectively.

Wedge plate 100 includes: end surface 116; end surface 118; and gap 120 between end surfaces 116 and 118. End surface 116 faces in direction CD1. End surface 118 faces in direction CD2. Wedge plate 100 is circumferentially continuous except at gap 120. Wedge plate 100 is a resilient element and is preloaded with force F resisting displacement of ends 116 and 118 in directions CD1 and CD2, respectively. Thus, wedge plate 100 resists being compressed radially inwardly.

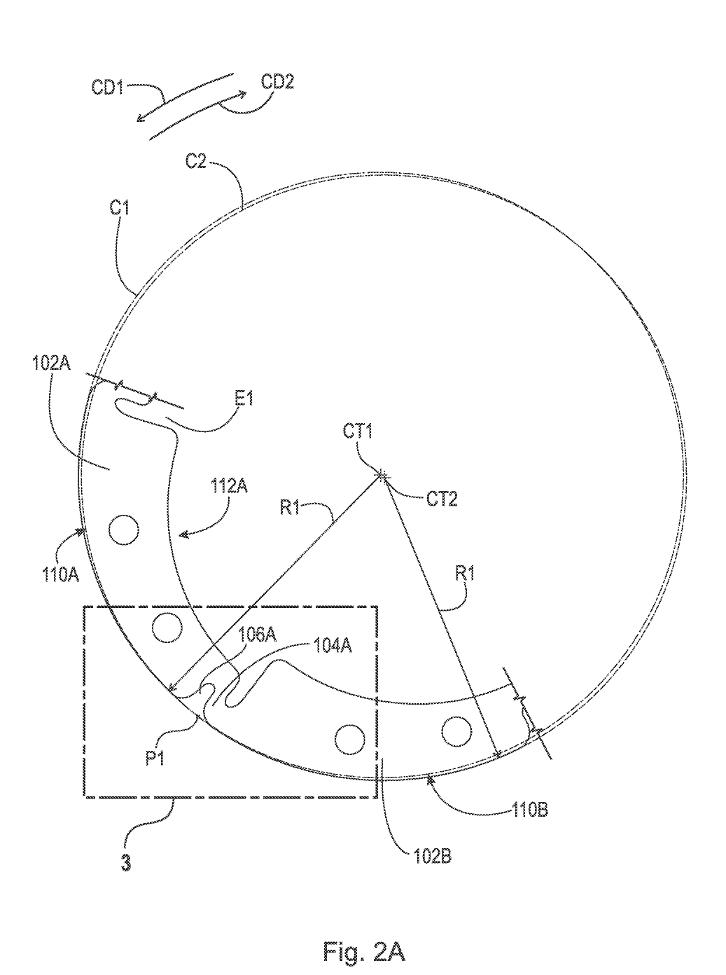

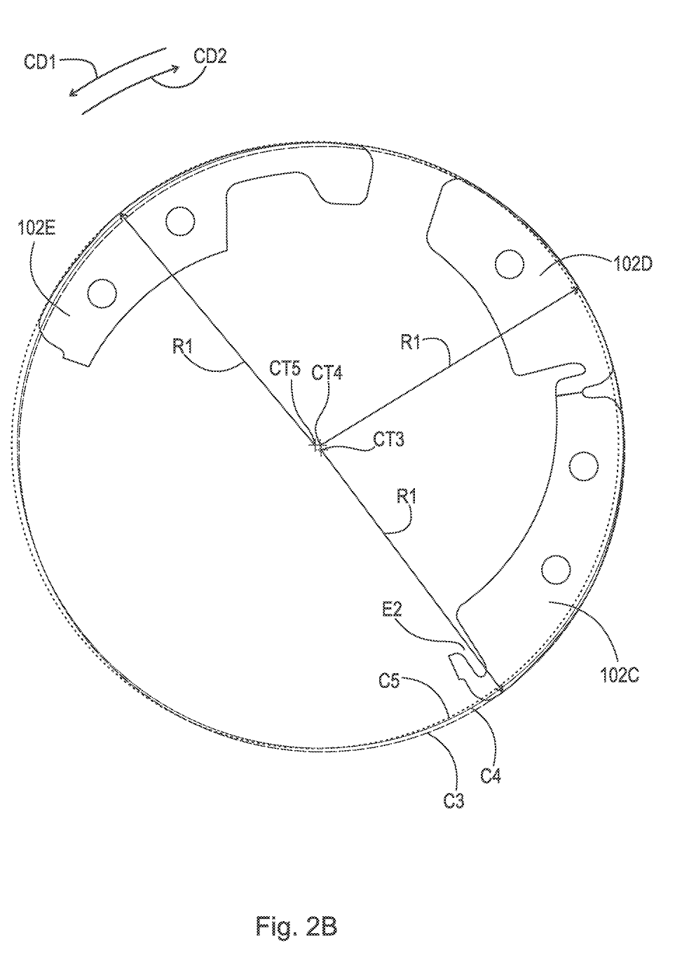

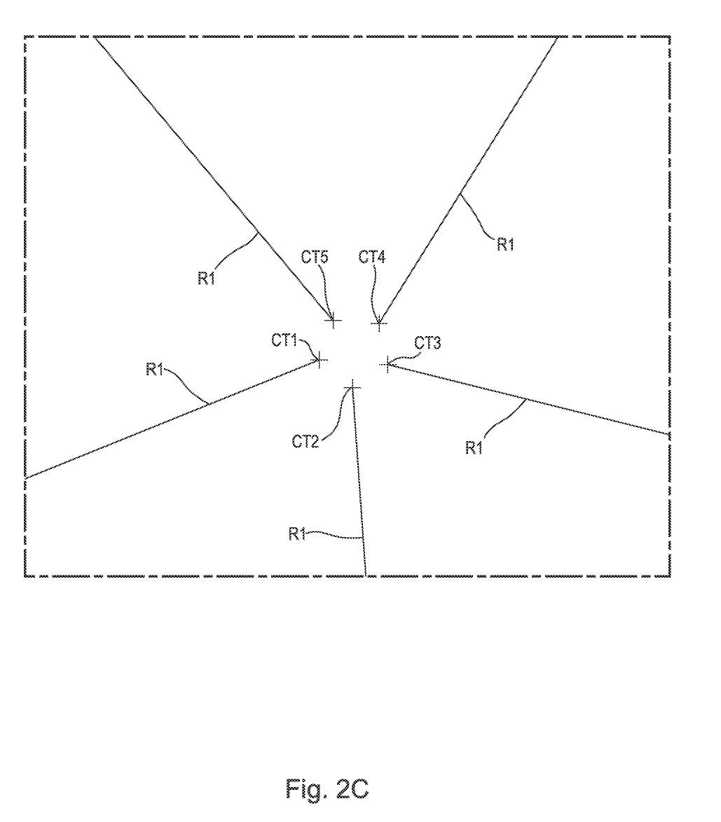

FIG. 2A shows two segments 102 for plate 100 from FIG. 1, illustrating rotation and tangential off-set of at least two segments 102 for wedge plate 100.

FIG. 2B shows the three remaining segments 102 for wedge plate 100 from FIG. 1, illustrating rotation and tangential off-set of segments 102 for wedge plate 100. The following should be viewed in light of FIGS. 1 through 2B. At least one segment 102 includes a surface 110 in the shape of a portion of a circle having radius R1. In an example embodiment, surface 110A is in the shape of a portion of circle C1 having radius R1 measured from center point CT1. In an example embodiment, at least two segments 102 include respective surfaces 110 in the shape of portions of respective circles having radius R1. For example, surfaces 110A and 110B are in the shape of respective portions of circles C1 and C2, respectively, having radii R1 measured from center points CT1 and CT2, respectively. In an example embodiment, every segment 102 includes a respective surface 110 in the shape of a portion of a respective circle having radius R1. For example, surfaces 110A, 110B, 110C, 110D and 110E are in the shape of respective portions of circles C1,C2, C3, C4 and C5, respectively, having radii R1 measured from center points CT1, CT2, CT3, CT4 and CT5, respectively. The discussion that follows is directed to each segment 102 including a respective surface 110 in the shape of a portion of a respective circle having radius R1. However, it should be understood that it is possible for one or more surfaces 110 to not be in the shape of a portion of a respective circle having radius R1.

Respective circles for at least a pair, for example a pair of circumferentially adjacent, surfaces 110 are not co-linear. That is, the respective portions for the pair of surfaces 110 are tangentially off-set as explained below. For example in FIG. 2A, circles C1 and C2 are not co-linear. For example, in FIG. 2B, circles C3, C4, and C5 are not co-linear. In the example of FIGS. 1 through 2B none of circles C1, C2, C3, C4 or C5 are co-linear. That is, the respective circle for the surface 110 for each segment 102 is non-co-linear with the respective circles for the surface 110 for every other segment 102.

FIG. 2C is a detail of area 2C in FIG. 1. The following should be viewed in light of FIGS. 1 through 2C. FIG. 2C shows an example configuration of center points CT1, CT2, CT3, CT4 and CT5.

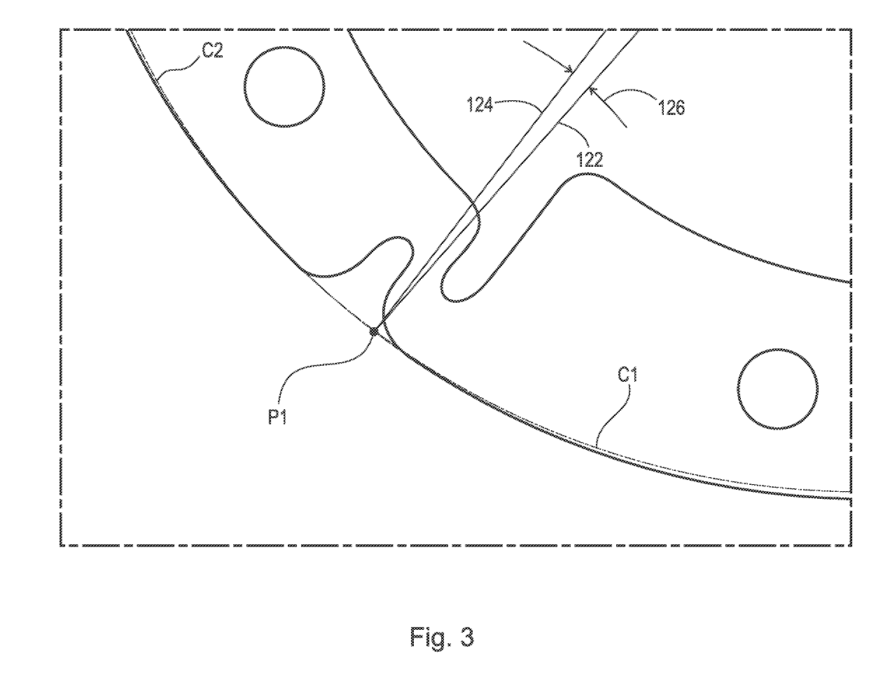

FIG. 3 is a detail of area 3 in FIG. 2A. The following should be viewed in light of FIGS. 1 through 3. The rotation and tangential off-set of segments 102A and 102B in FIG. 3 has been exaggerated to better show the rotation and tangential off-set. Circles C1 and C2 intersect at point P1. Radial line 122 is a radius for circle C1 at point P1. Radial line 124 is a radius for circle C2 at point P1. Lines 122 and 124 are not co-linear. Thus, angle 126 is formed by lines 122 and 124 and illustrates the tangential off-set between surfaces 110A and 110B. If segments 102A and 102B were not rotated and tangentially off-set, for example as shown above for the prior art wedge plate, a single circle would be co-linear with surfaces 110A and 110B, in which case, there could not be non-co-linear radii passing through a same point in the circle. Angle 126 can be the same for each pair of circumferentially adjacent and tangentially off-set pair of surfaces 110 or angle 126 can vary for circumferentially adjacent and tangentially off-set pairs of surfaces 110. In an example embodiment, angle 126 is less than one degree. In an example embodiment, angle 126 is less than 0.5 degrees. In an example embodiment, angle 126 is less than 0.4 degrees.

In the example of FIGS. 1 through 3, the circle for each segment 102 is radially inward of at least a portion of the outer surface 110 for at least one other segment 102. For example: circle C1 is radially inward of at least a portion of surface 110B; circle C2 is radially inward of at least a portion of surface 110A; C3 is radially inward of at least portions surfaces 110D and 110E; C4 is radially inward of at least portions surfaces 110C and 110E; and C5 is radially inward of at least portions surfaces 110C and 110D. For example: all of circle C3 is radially inward of surface 110E; and all of circle C5 is radially inward of surface 110C.

In the example of FIGS. 1 through 3, no portion of a circle for a segment 102 is radially outward of surface 110 for a circumferentially adjacent segment 102. For example: no portion of circle C1 is radially out ward of surface 1106; no portion of circle C2 is radially inward of 110A; no portion of circle C3 is radially inward of surface 110D; no portion of circle C4 is radially out ward of surface 110C or surface 110E; and no portion of circle C5 is radially outward of surface 110D.

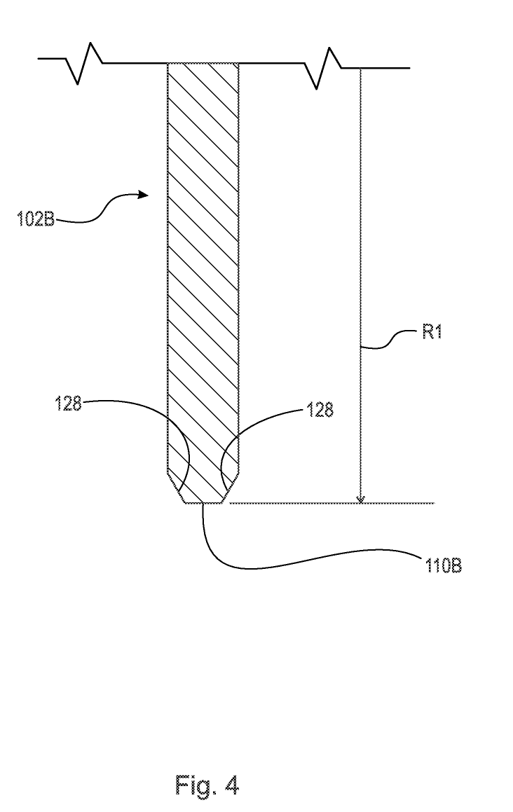

FIG. 4 is a cross-sectional view generally along line 4-4 in FIG. 1. The following should be viewed in light of FIGS. 1 through 4. In an example embodiment, each segment 102 includes radially outwardly tapered surfaces 128 converging at surface 110.

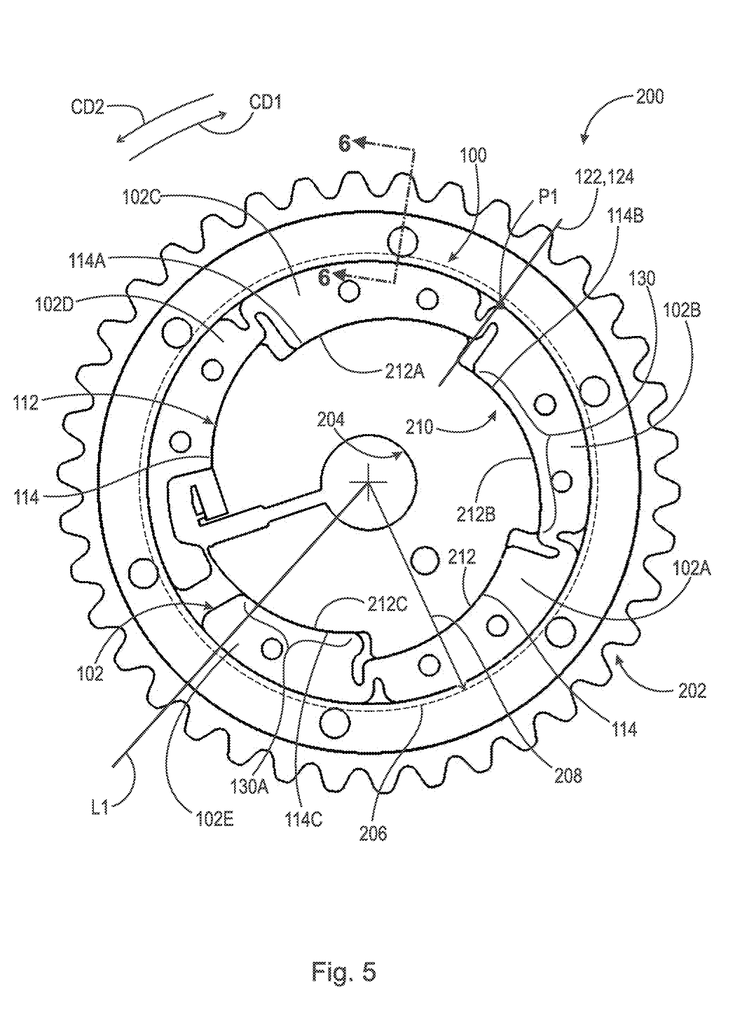

FIG. 5 is a front view of wedge plate clutch 200, with wedge plate 100 shown in FIG. 1, in a locked mode.

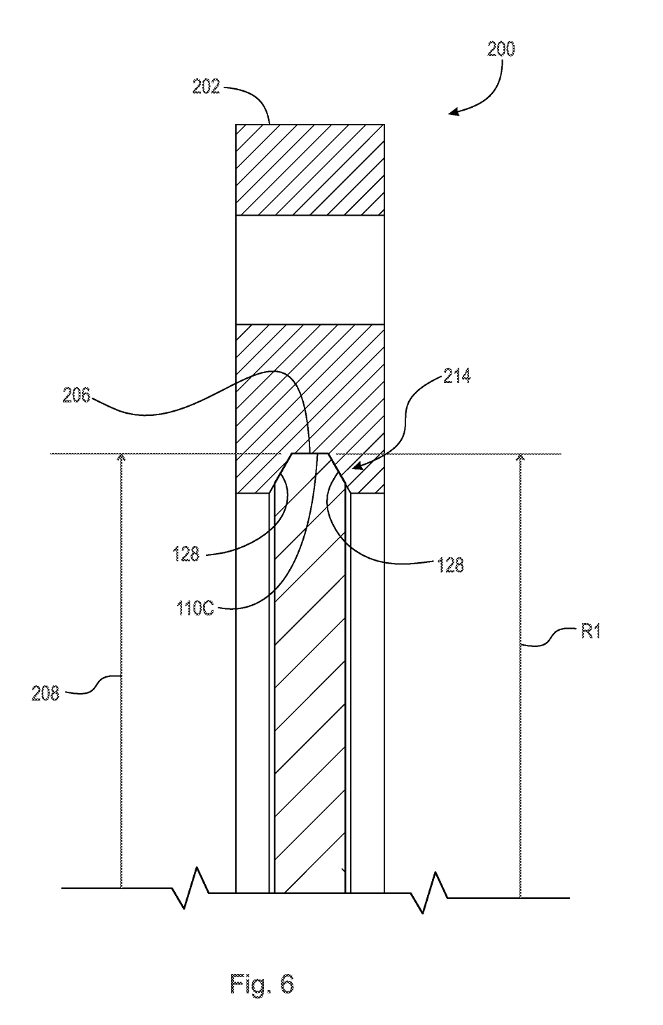

FIG. 6 is a cross-sectional view generally along line 6-6 in FIG. 5. The following should be viewed in light of FIGS. 1 through 6. Clutch 200 includes axis of rotation AR, outer race 202, inner race 204, and wedge plate 100. Outer race 202 includes radially inner surface 206 at uniform radial distance 208 from axis of rotation AR. In the locked mode for clutch 200, outer race 202, inner race 204 and clutch plate 100 are non-rotatably connected. By “non-rotatably connected” elements, we mean that: the elements are connected so that whenever one of the elements rotate, all the elements rotate; and relative rotation between the elements is not possible. Radial and/or axial movement of non-rotatably connected elements with respect to each other is possible, but not required.

In an example embodiment, each surface 110 forms a portion of a circle having radius R1. Radius R1 is equal to distance 208. In an example embodiment, at least one surface 110, but less than every surface 110, forms a portion of a respective circle having a radius R1 equal to distance 208. Radii R1 are measured from axis AR. Inner race 204 includes radially outer surface 210 with ramps 212 extending radially outwardly along circumferential direction CD1.

Wedge plate 100 is radially disposed between races 202 and 204. Each ramp 212 is engaged with ramp 114 for a respective segment 102. For example, ramps 212A and 212B are in contact with ramps 114A and 114B, respectively. In the example of FIGS. 5 and 6, wedge plate 100 includes tapered surfaces 128. In the example of FIGS. 5 and 6, surface 206 is formed by groove 214. Portion 130 of each ramp 114 is the full extent of each ramp 114 radially aligned with a respective ramp 212. By “radially aligned,” we mean that any line, orthogonal to the axis or rotation, passing through portion 130 also passes through the respective ramp 212. For example, line L1 in FIG. 5 passes through portion 130A of ramp 114C and through ramp 212C.

As is known in the art, from the locked mode for clutch 200 and for relative rotation of inner race 204 with respect to outer race 202 in circumferential direction CD1, wedge plate clutch 200 transitions to an open mode in which outer race 202 and inner race 204 are rotatable with respect to each other. For example, ramps 212 along ramps 114 to radially retract wedge plate 100. In the open mode, there is frictional contact between surfaces 110 and surface 206. For example, for segments 102A and 102B, when wedge plate 100 is installed in clutch 200, force F forces surfaces 110 into contact with surface 206.

As is known in the art, from the open mode and for relative rotation of inner race 204 with respect to outer race in circumferential direction CD2, wedge plate clutch 200 transitions to the locked mode. For example, when inner race 204 rotates in direction CD2 with respect to race 202, the rotation of race 204 urges wedge plate 100 in direction CD2. However, the frictional contact between surfaces 110 and 206 resists the rotation of wedge plate 100 in direction CD2 so that ramps 212 slide along ramps 114 in direction CD2, pushing wedge plate 100 (in particular, surfaces 110) radially outwardly to non-rotatable connect plate 100 to races 202 and 204.

In an example embodiment, in the locked mode for clutch 200, 100 percent of each surface 110 is in contact with surface 206. Therefore, lines 122 and 124, passing through point P1, are co-linear in clutch 200. In an example embodiment, in the locked mode for clutch 200, 75 percent to less than 100 percent of each surface 110 is in contact with surface 206. In an example embodiment, in the locked mode for clutch 200, 50 percent to less than 75 percent each surface 110 is in contact with surface 206. In an example embodiment, in the locked mode for clutch 200, 25 percent to less than 50 percent each surface 110 is in contact with surface 206. In an example embodiment, in the locked mode for clutch 200, 10 percent to less than 25 percent each surface 110 is in contact with surface 206. It should be understood that in the locked mode, other ranges of contact are possible for each surface 110 in contact with surface 206. It should be understood in the locked mode, the percent of each surface 110 in contact with surface 206 can be different for different segments 102 in clutch 200.

In an example embodiment, in the open mode for clutch 200, 100 percent of each surface 110 is in contact with surface 206. In an example embodiment, in the open mode for clutch 200, 75 percent to less than 100 percent of each surface 110 is in contact with surface 206. In an example embodiment, in the open mode for clutch 200, 50 percent to less than 75 percent of each surface 110 is in contact with surface 206. In an example embodiment, in the open mode for clutch 200, 25 percent to less than 50 percent of each surface 110 is in contact with surface 206. In an example embodiment, in the open mode for clutch 200, 10 percent to less than 25 percent of each surface 110 is in contact with surface 206. It should be understood that in the open mode, other ranges of contact between each surface 110 and surface 206 are possible. It should be understood that in the open mode, the percent of each surface 110 in contact with surface 206 can be different for different segments 102 in clutch 200.

It should be understood that for a particular segment 102, the percent of each surface 110 in contact with surface 206 can be different for the closed and open modes.

In an example embodiment, in the locked mode for clutch 200, 100 percent of each portion 130 is in contact with the respective ramp 212. In an example embodiment, in the locked mode for clutch 200, 75 percent to less than 100 percent of each portion 130 is in contact with the respective ramp 212. In an example embodiment, in the locked mode for clutch 200, 50 percent to less than 75 percent of each portion 130 is in contact with the respective ramp 212. In an example embodiment, in the locked mode for clutch 200, 25 percent to less than 50 percent of each portion 130 is in contact with the respective ramp 212. In an example embodiment, in the locked mode for clutch 200, 10 percent to less than 25 percent of each portion 130 is in contact with the respective ramp 212. It should be understood that in the locked mode, other ranges of contact between portions 130 and ramps 212 are possible. It should be understood that for the locked mode, the percent of portion 130 and ramp 212 in contact can be different for different segments 102 in clutch 200.

In an example embodiment, in the open mode for clutch 200, 100 percent of each portion 130 is in contact with the respective ramp 212. In an example embodiment, in the open mode for clutch 200, 75 percent to less than 100 percent of each portion 130 is in contact with the respective ramp 212. In an example embodiment, in the open mode for clutch 200, 50 percent to less than 75 percent of each portion 130 is in contact with the respective ramp 212. In an example embodiment, in the open mode for clutch 200, 25 percent to less than 50 percent of each portion 130 is in contact with the respective ramp 212. In an example embodiment, in the open mode for clutch 200, 10 percent to less than 25 percent of each portion 130 is in contact with the respective ramp 212. It should be understood that in the open mode, other ranges of contact between portions 130 and ramps 212 are possible. It should be understood that for the open mode, the percent of portion 130 and ramp 212 in contact can be different for different segments 102 in clutch 200.

It should be understood that for a particular segment 102, the percent of portion 130 and ramp 212 in contact can be different for the closed and open modes.

The following should be viewed in light of FIGS. 1 through 6. The following describes a method of operating a wedge plate clutch, for example clutch 200, including: an inner race, for example race 204 with a first radially outer surface, for example surface 210, having a first ramp, for example ramp 212A, sloping radially outwardly in a first circumferential direction, for example direction CD1, about an axis of rotation, for example axis AR, for the wedge plate clutch; an outer race, for example race 202 including a first radially inner surface, for example surface 206, at a uniform radial distance from the axis of rotation, for example distance 208; and a wedge plate, radially disposed between the inner and outer races, for example wedge plate 100, and including a segment with a second radially outer surface in the shape of a portion of a circle having a radius equal to the radial distance, for example surface 110A, circle C1 and radius R, and with a second radially inner surface including a second ramp sloping radially outward in the first circumferential direction, for example surface 112A and ramp 114A. A first step contacts the second radially outer surface with the first radially inner surface. A second step contacts the first and second ramps. A third step rotates the inner race in a second circumferential direction, opposite the first circumferential direction, for example direction CD2. A fourth step slides, in the second circumferential direction, the first ramp along the second ramp. A fifth step displaces the wedge plate radially outwardly. A sixth step non-rotatably connects the inner race, the wedge plate and the outer race.

In an example embodiment, a seventh step: contacts the first radially inner surface with 100 percent of the second radially outer surface; or contacts the first radially inner surface with 75 percent to less than 100 percent of the second radially outer surface; or contacts the first radially inner surface with 50 percent to less than 75 percent of the second radially outer surface; or contacts the first radially inner surface with 25 percent to less than 50 percent of the second radially outer surface.

In an example embodiment an eighth step: contacts the first ramp with 100 percent of a full extent of the second ramp radially aligned with the first ramp; or contacts the first ramp with 75 percent to less than 100 percent of a full extent of the second ramp radially aligned with the first ramp; or contacts the first ramp with 50 percent to less than 75 percent of a full extent of the second ramp radially aligned with the first ramp; or contacts the first ramp with 25 percent to less than 50 percent of a full extent of the second ramp radially aligned with the first ramp; or contacts the first ramp with 10 percent to less than 25 percent of a full extent of the second ramp radially aligned with the first ramp.

In an example embodiment, the first radially outer surface includes a third ramp sloping radially outwardly in the first circumferential direction, for example ramp 212B, and the wedge plate includes a second segment with a third radially outer surface in the shape of a portion of a second circle having a radius equal to the radial distance and with a third radially inner surface including a fourth ramp sloping radially outwardly in the first circumferential direction, for example segment 102B, surface 110B, and circle C2. A ninth step contacts the first radially inner surface with the third radially outer surface. A tenth step contacts the third ramp with the fourth ramp.

Wedge plate 100 and wedge plate clutch 200 solve the problem noted above regarding limited contact, in a locked mode, between a wedge plate in a wedge plate clutch and the inner and outer races of the clutch. Specifically, in the locked mode, for a wedge plate clutch, such as clutch 200, including plate 100, the area of contact between wedge plate 100 and outer race 202 and between wedge plate 100 and inner race 204 is greatly increased, in comparison to the prior art wedge plate clutch discussed above. Thus, wedge plate clutch 200 has an increased torque-carrying capacity in comparison to known wedge plate clutches having a single similarly sized wedge plate.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### LIST OF REFERENCE CHARACTERS

10 cylindrical system
11 axis of rotation
AD1 axial direction
AD2 axial direction
RD1 radial direction
RD2 radial direction
CD1 circumferential direction
CD2 circumferential direction
R radius
12 object
13 object
14 object
15A surface
15B surface
15C edge
16A surface
16B edge
17A radius
17B radius
18 surface
19 circumference
20 radius
C1 circle
C2 circle
C3 circle
C4 circle
C5 circle
CT1 circle center
CT2 circle center
CT3 circle center
CT4 circle center
CT5 circle center
F force
L1 line
R1 radius
100 wedge plate
102 segment, wedge plate
102A segment
102B segment
102C segment
102D segment
102E segment
104 segment, wedge plate
104A segment
106 slot
106A slot
108 slot
108A slot
110 outer circumferential surface
110A outer circumferential surface
110B outer circumferential surface
112 inner circumferential surface
112A inner circumferential surface
112B inner circumferential surface
114 ramp, surface 112
114A ramp, surface 112
114B ramp, surface 112
114C ramp, surface 112
116 end surface
118 end surface
120 gap
122 radius
124 radius
126 angle
128 tapered surface
130 portion, ramp 114
130A portion, ramp 114
200 wedge plate clutch
202 outer race
204 inner race
206 radially inner surface, race 202
208 radial distance
210 radially outer surface, race 204
212 ramp, surface 208
212A ramp, surface 208
212B ramp, surface 208
212C ramp, surface 208
214 groove, surface 206
300 prior art wedge plate
302 segment
302A segment
302B segment
302C segment
302D segment
302E segment
304 segment
306 radially outer surface
308 radially inner surface
310 ramp
312 wedge plate clutch
314 outer race
316 inner race
318 radially inner surface
320 radial distance
322 ramp
324 area of contact

1. A wedge plate for a wedge plate clutch, comprising:
a first plurality of segments including:
a first segment with:
a first radially outer surface in a shape of a portion of a first circle; and,
a first radially inner surface including a first ramp extending radially outwardly in a first circumferential direction; and,
a second segment with:
a second radially outer surface in a shape of a portion of a second circle, the second circle non-co-linear with the first circle; and,
a second radially inner surface including a second ramp extending radially outwardly in the first circumferential direction; and,
a second plurality of segments, each segment in the second plurality of segments connecting a respective pair of circumferentially adjacent segments included in the first plurality of segments.

2. The wedge plate of claim 1, wherein the first and second circles have a same radius.

3. The wedge plate of claim 1, wherein:
each segment in the first plurality of segments includes a respective radially outer surface in a shape of a portion of a respective circle; and,
each respective circle has a same radius.

4. The wedge plate of claim 3, wherein each respective circle is non-co-linear with every other respective circle.

5. The wedge plate of claim 3, wherein each respective circle is non-co-linear with at least one other respective circle.

6. The wedge plate of claim 1, further comprising:
a first slot:
circumferentially disposed between the first segment and a segment included in the second plurality of segments; and,
extending radially inwardly from the first radially outer surface; and,
a second slot:
circumferentially disposed between the second segment and the segment included in the second plurality of segments; and,
extending radially outwardly from the second radially inner surface.

7. The wedge plate of claim 1, wherein:
the first and second segments are circumferentially adjacent;
the first and second circles intersect at a first point;
a first line is orthogonal to the first circle and passes through the first point;
a second line is orthogonal to the second circle and passes through the first point; and,
the first line is not co-linear with the second line.

8. The wedge plate of claim 7, wherein an acute angle is formed between the first and second lines.

9. The wedge plate of claim 7, wherein the first and second lines pass through a segment included in the second plurality of segments.

10. The wedge plate of claim 1, further comprising:
a first end surface facing in the first circumferential direction;
a second end surface facing in a second circumferential direction; and,
a gap, in the first circumferential direction, between the first surface and the second surface, wherein:
the wedge plate is circumferentially continuous except at the gap; and,
the wedge plate is resilient and pre-loaded with a force urging the first and second end surfaces in the second and first circumferential directions, respectively.

11. The wedge plate of claim 1, wherein:
at least a portion of the first circle is radially inward of the second radially outer surface; and,
at least a portion of the second circle is radially inward of the first radially outer surface.

12. The wedge plate of claim 1, wherein:
no portion of the first circle is radially outward of the second radially outer surface; and,
no portion of the second circle is radially outward of the first radially outer surface.

13. A wedge plate clutch, comprising:
an axis of rotation;
an outer race with a first radially inner surface at a radial distance from the axis of rotation;
an inner race; and,
a wedge plate radially disposed between the inner race and the outer race and including a first plurality of segments, the first plurality of segments including:
a first segment with a first radially outer surface:
in contact with the first radially inner surface; and,
in a shape of a portion of a first circle having a radius equal to the radial distance; and,
a second segment with a second radially outer surface:
in contact with the first radially inner surface; and,
in a shape of a portion of a second circle having a radius equal to the radial distance.

14. The wedge plate clutch of claim 13, wherein:
the inner race includes a third radially outer surface including a first plurality of ramps, each ramp extending radially outwardly along a first circumferential direction;
the first segment includes a second radially inner surface including a first ramp in contact with the first plurality of ramps;
the second segment includes a third radially inner surface including a second ramp in contact with the first plurality of ramps;
the wedge plate includes a second plurality of segments, each segment in the second plurality of segments connecting a respective pair of circumferentially adjacent segments included in the first plurality of segments; and,
for relative rotation of the inner race with respect to the outer race in a second circumferential direction, opposite the first circumferential direction, the inner race displaces the wedge plate radially outwardly to non-rotatably connect the inner race, the wedge plate and the outer race.

15. The wedge plate clutch of claim 13, wherein each segment included in the first plurality of segments includes a respective radially outer surface:
in contact with the first radially inner surface; and,
in a shape of a portion of a respective circle having a radius equal to the radial distance.

16. The wedge plate clutch of claim 13, wherein:
the wedge plate includes:
a first end surface facing in a first circumferential direction;
a second end surface facing in a second circumferential direction; and,
a gap, in the first circumferential direction, between the first surface and the second surface; and,
the wedge plate is circumferentially continuous except at the gap.

17. A method of operating a wedge plate clutch, the wedge clutch including: an inner race with a first radially outer surface having a first ramp sloping radially outwardly in a first circumferential direction about an axis of rotation for the wedge plate clutch; an outer race including a first radially inner surface at a uniform radial distance from the axis of rotation; and a wedge plate radially disposed between the inner and outer races, the wedge plate including a first segment with a second radially outer surface in a shape of a portion of a first circle having a radius equal to the uniform radial distance and with a second radially inner surface including a second ramp sloping radially outwardly in the first circumferential direction, the method comprising:
contacting the first radially inner surface with the second radially outer surface;
contacting the first ramp with the second ramp;
rotating the inner race in a second circumferential direction, opposite the first circumferential direction;
sliding, in the second circumferential direction, the first ramp along the second ramp;
displacing the wedge plate radially outwardly; and,
non-rotatably connecting the inner race, the wedge plate and the outer race.

18. The method of claim 17, wherein non-rotatably connecting the inner race, the wedge plate and the outer race includes:
contacting the first radially inner surface with 100 percent of the second radially outer surface; or,
contacting the first radially inner surface with 75 percent to less than 100 percent of the second radially outer surface; or,
contacting the first radially inner surface with 50 percent to less than 75 percent of the second radially outer surface; or,
contacting the first radially inner surface with 25 percent to less than 50 percent of the second radially outer surface; or,
contacting the first radially inner surface with 10 percent to less than 25 percent of the second radially outer surface.

19. The method of claim 17, further comprising:
contacting the first ramp with 100 percent of a full extent of the second ramp radially aligned with the first ramp; or,
contacting the first ramp with 75 percent to less than 100 percent of a full extent of the second ramp radially aligned with the first ramp; or,
contacting the first ramp with 50 percent to less than 75 percent of a full extent of the second ramp radially aligned with the first ramp; or,
contacting the first ramp with 25 percent to less than 50 percent of a full extent of the second ramp radially aligned with the first ramp; or,
contacting the first ramp with 10 percent to less than 25 percent of a full extent of the second ramp radially aligned with the first ramp.

20. The method of claim 17, wherein the first radially outer surface includes a third ramp sloping radially outwardly in the first circumferential direction and the wedge plate includes a second segment with a third radially outer surface in a shape of a portion of a second circle having a radius equal to the radial distance and with a third radially inner surface including a fourth ramp sloping radially outwardly in the first circumferential direction, the method further comprising:
contacting the first radially inner surface with the third radially outer surface; and,
contacting the third ramp with the fourth ramp.
